(19) United States
(12) Patent Application Publication
(10) Pub. No.: US 2019/0272774 A1
(43) Pub. Date: Sep. 5, 2019

(54) Fitness and Educational Game and Method of Playing the Same

(71) Applicant: DQPN, LLC, Detroit, MI (US)

(72) Inventor: David L. Katz, Hamden, CT (US)

(21) Appl. No.: 16/414,099

(22) Filed: May 16, 2019

Related U.S. Application Data
(63) Continuation of application No. 15/246,146, filed on Aug. 24, 2016.
(60) Provisional application No. 62/297,344, filed on Feb. 19, 2016.

(51) Int. Cl. G09B 19/00; G09B 29/00

(52) U.S. Cl. CPC G09B 19/0092; G09B 29/00

(57) ABSTRACT

A fitness and education game and method of playing the same method for increasing health awareness. The game includes a plurality of unique photographic images, wherein each unique photographic image depicts a different objective level of diet quality for a different type of diet for a period of time and depicts representative types and quantities of foods and/or beverages consumed at the level of diet quality for the type of diet for the period of time. The game also a diet quality map comprising a grid of cells. Each unique photographic image corresponds to a cell in the grid of cells and each photographic image represents a dietary variant or pattern of a level of diet quality for a type of diet; and. The game also includes instructions for one or more players to navigate through the grid of cells from a BASELINE level of diet quality to a more optimal level of diet quality.

### FIELD OF THE INVENTION

The present invention relates generally to a method for capturing baseline diet composition, goal (desired) diet composition, and providing step-by-step guidance from baseline to goal via a customized, preferred “route”—experienced by the user.

### BACKGROUND OF THE INVENTION

Good diet quality is a major contributing factor to the health and well-being of individuals and families. However, in order to evaluate diet quality, it is necessary to obtain information regarding current dietary intake of the individual and/or household.

Conventional dietary intake measures, including, for example, food frequency questionnaires, food diaries, dietary recall, are notoriously prone to inaccuracies despite being very labor-intensive. They are, in fact, labor intensive for both the “client” and the professionals (i.e., dietitians, nutrition researchers) who rely on them for data. Because they are tedious, cumbersome, and not user-friendly, they are ill-suited to consumer-facing applications that are intended to be “inviting” or fun to use, such as apps on smart phones or other wearable technology (e.g. smart watches). In contrast, there is a bounty of fitness applications that can be easily used in just such settings with no cumbersome data entry at the start.

Food frequency questionnaires require that a user completes an extensive, detailed questionnaire document in paper or on-line format. Even then, the result is notoriously prone to inaccuracies due to the need to estimate intake of diverse foods, and choose representative foods from the inventory provided. Food diaries and 24-hour diet recall require the recording of foods at the time of consumption, or depending on memory, and involve writing down details about foods and quantities and again require considerable time. A 7-day food diary may require hours of work. Finally, each of these methods requires individualized dietary analysis of the intake reported, generally involving specific software packages for nutrition analysis and a dietitian trained in their use. This step converts the reported intake of foods into information about intake of macronutrients and micronutrients.

All current, prevailing methods of dietary intake assessment, other than metabolic ward studies which are prohibitively expensive and inconvenient for routine application, require food-by-food and meal-by-meal narrative description of intake. In addition, as discussed above, these methods either require real-time journaling, or depend on recall.

Methods currently in the pipeline representing innovation/advances substitute photographic image capture for narrative description, but are otherwise the same in all respects. Such photograph-based methods still depend on food-by-food and meal-by-meal information capture; are labor intensive and time consuming for the consumer, requiring n-of-1 data entry; are labor intensive and time consuming for researchers and health professionals, requiring n-of-1 data analysis to determine nutrient intake levels, salient food factors, and objective measures of overall diet quality. Image-based dietary reporting might alleviate the burden of describing foods narratively for the consumer, but if anything compounds the analytical burden for the researcher, clinician, or coach, who must translate each image into the information about food composition and quantity the narrative would have provided, and then still append a personalized nutrient analysis.

Furthermore, while existing methods are suitable for individuals, they are not readily adapted to the level of whole households. In addition, application to children is historically very difficult. The errors in such methods are of a magnitude that some have deemed them altogether invalid. Methods in the pipeline do not promise reliably to fix these problems. The technology on which they depend introduces new potential problems, including but not limited to: need for Internet access; need for expensive hardware; need for reliable light for photography; need for extensive data transfer; potential risk of privacy compromise by fixed cameras; the need for diverse ‘consumers’ to learn the use of the technology; etc.

Thus, it can be seen that there is, to date, no method, in practice or conceived, to reverse-engineer this process. In other words, there is no method that uses a diet quality score to generate a representative diet and express it as a photographic image.

U.S. Pat. No. 6,585,516 to Alabaster, the subject matter of which is herein incorporated by reference in its entirety, describes a system and method for computerized visual behavior analysis, training and planning in which the user uses picture menus to choose meals for a particular time period to correspond to a customize eating plan. However, the picture menus consist of a series of instant meals that the user can mix and match at various nutritional, caloric, and other levels and can be used as a meal builder. In this instance, the user chooses the diet he wants to follow. However, the downside to this method is that the user must choose and build their meals for the day to meet a dietary goal, which can be a time consuming process. In addition, the user may not know what constitutes, a “good”, “better” or “best” choice for a given category of foods or beverages. Most importantly, each image represents a meal, not a dietary pattern.

U.S. Pat. No. 6,553,386 to Alabaster describes a computerized visual behavior analysis and training method in which the user interacts with a series of displays. A computer database includes information enabling display on a screen of a plurality of objects, in successive groups, together with a display of graphics associated with each groups. The graphics allow a first user selection of one of the objects of each group and a second user selection related to the object selected by interaction with the screen display. The user selections may comprise food choices and evaluation of enthusiasm, and frequency thereof, so as to produce a dietary behavior profile. Diet training may then be coordinated by display of a meal and interactive adjustment of food items and portion sizes.

U.S. Pat. No. 7,558,788 to Herdman, the subject matter of which is herein incorporated by reference in its entirety, describes a system/method for distributing personalized information over a communication system and uses a filtering system to generate a customized list of solution elements based on selected questions. However this method still requires the user to input information into a lengthy questionnaire.

There remains a need for an improved method of characterizing habitual and desired food/beverage intake and incremental change in diet in a straightforward and simple manner. In particular, there is, to date, no streamlined, user-friendly, and universally applicable means to capture the diet composition and quality of an individual or household in a straightforward and simple manner.

In addition, there is currently no convenient or efficient way to get good dietary information about an individual or a household without the time and effort required for preparing and analyzing a food diary or related data source. There is also no good way to monitor the progress of an individual or a household in adopting new dietary habits in a quick, convenient, and efficient manner. There is currently no good way to identify whether a user or household has reached a goal of improving their diet in a fun, fast and user friendly manner. Finally, there is no way for researchers to obtain information about dietary intake that does not require analysis of diet composition each time at the level of individual data entry. There is no method to establish dietary intake using pre-analyzed representations of diet that obviate individual analysis, allowing for infinite scalability.

The process described herein introduces a novel approach to the assessment of dietary intake, and guidance toward any given dietary goal. Rather than collating error-prone information about individual foods and meals, whether by narrative description or image capture, in an attempt to assemble an approximation of overall dietary pattern and nutrient intake, the process described herein presents a regionally, culturally, and personally relevant library of photographs representing plausible, fully-formed, fully analyzed dietary patterns, and through a brief sequence of selections exactly analogous to the process for customizing an eyeglass lens prescription, identifies the “best fit.” The process described herein is designed to operate in any technology platform (e.g., apps, interactive websites, and wearable health technology) and can also be used in the field without any technology, and independent of language and literacy.

The process described herein solves all of the problems noted above by eliminating the need for food-by-food description entirely, whether with narrative or images, and requiring no technology, while suitable for use in almost any interactive technology platform. By providing infinite scalability with pre-analyzed dietary patterns, the method fully relieves the data analysis burden for researchers, offering potentially huge economies of scale.

### SUMMARY OF THE INVENTION

It is an object of the present invention to obtain an accurate representation of an individual's habitual dietary pattern.

It is another object of the present invention to obtain a qualitative representation of an individual's habitual dietary pattern.

It is another object of the present invention to obtain a quantitative representation of an individual's habitual dietary pattern.

It is another object of the present invention to obtain a qualitative representation of a household's habitual dietary pattern.

It is still another object of the present invention to obtain a quantitative representation of a household' habitual dietary pattern.

It is yet another object of the present invention to obtain a reliable measure of overall diet quality.

It is still another object of the present invention to provide a pictorial inventory representative of an individual or household's habitual diet pattern.

It is still another object of the present invention to provide a customizable photo library (i.e., regionally, culturally, and/or personally relevant photo library) for which analytics regarding dietary pattern have been completed.

It is still another object of the present invention to provide a photographical representation of diet quality for which analytics related to the quality of the diet represented by the photograph(s) have been completed.

It is yet another object of the present invention to provide a photographical representation of dietary goals.

It is yet another object of the present invention to provide a photographical representation of incremental dietary goals.

It is another object of the present invention to use the customizable photo library to assess dietary intake of an individual or household.

It is another object of the present invention to establish a desired goal diet using the customizable photo library.

It is another object of the present invention to define a sequence of incremental steps leading from baseline to goal diets.

It is another object of the present invention to provide customized routes from baseline to goal diets by means of sequencing the incremental dietary changes required.

It is still another object of the present invention to provide quantitative dietary intake details for each information by use of a pre-analyzed diet and information to determine energy intake, namely: height, weight, age, sex and customary physical activity level.

It is yet another object of the present invention to provide for the development of photo libraries tailored to cultural and regional dietary intake variants around the world.

It is still another object of the present invention to provide any given user of the system described herein access to a customized version of the photo library limited to the relevant dietary intake variants.

To that end, in one embodiment, the present invention relates generally to a method for translating levels of diet quality into photographic representations of dietary pattern, the method comprising the steps of:

a) using a diet quality measure to identify a plurality of dietary patterns that each represent a level of diet quality for a period of time;

b) assigning a dietary score to each of the plurality of dietary patterns;

c) converting the plurality of dietary patterns into representative dietary patterns; and

d) converting the representative dietary patterns into food photographs, wherein the food photographs depict the photographic representation of the dietary patterns for the period of time.

In another embodiment, the present invention relates generally to a computer system for evaluating and customizing diet quality, the computer system comprising:

a user interface;

a photographic library comprising an expandable archive of food photographs, wherein each of the food photographs in the expandable archive of food photographs depict a photographic representation of a dietary pattern for a period of time;

a database comprising information related to dietary patterns and nutrient data;

a user information system for allowing a user to enter user data related to the user with the user interface;

a selecting system for allowing the user to select one or more food photographs from the photographic library; and

a processor, wherein said processor is capable of translating a food photograph into a corresponding, objective, validated diet quality score by a chosen metric.

### BRIEF DESCRIPTION OF THE FIGURES

FIG. 1 depicts a photographic representation of a standard American dietary pattern.

FIG. 2 depicts a photographic representation of a standard French dietary pattern.

FIG. 3 depicts a photographic representation of a standard Mediterranean-style dietary pattern.

While the images shown above display both food and families, the intent for the diet quality photographic navigation (DQPN) described herein is to show FOOD ONLY, arranged in a manlier to convey more clearly the specific, distinguishing features of that diet at a virtual glance.

### DETAILED DESCRIPTION OF THE INVENTION

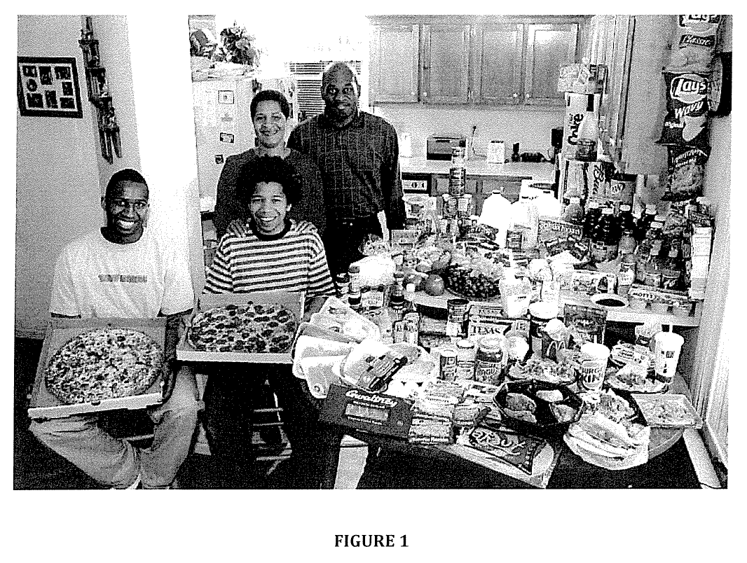

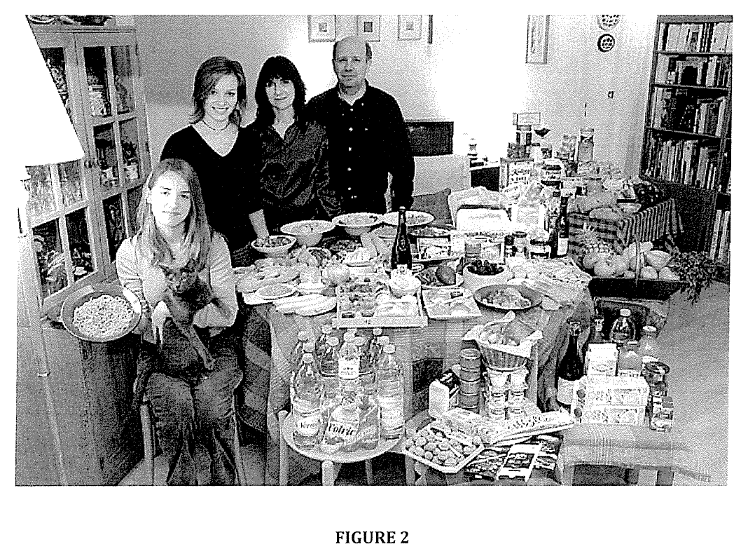

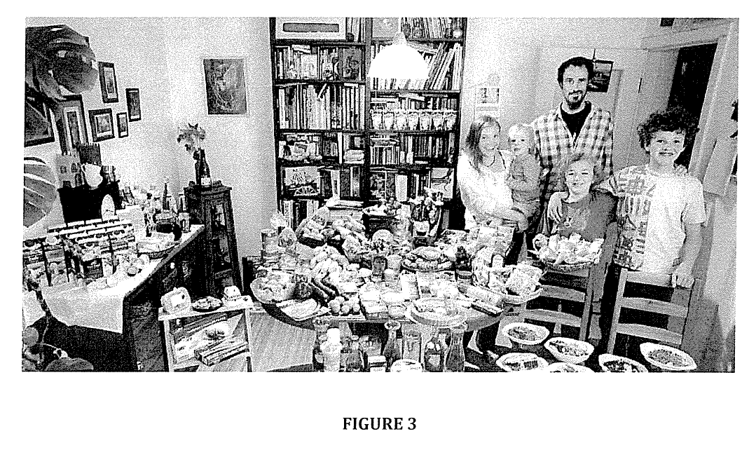

The idea that dietary pattern can be expressed with a photographic image is well established in the realm of entertainment and basic information exchange. For example, Hungry Planet: What the World Eats, by Peter Menzel and Faith D'Aluisio (2006) is filled with images of families from different cultures around the world, and their customary food for a week. Several of these images are shown in FIGS. 1-3, which depict a photographic representation of a standard American dietary pattern (FIG. 1), a standard French dietary pattern (FIG. 2) and a standard Mediterranean-style dietary pattern (FIG. 3) for a week. Note that these images are shown here as representations ONLY. The intent for the process of the present invention is to develop an exclusive library of food photographs, with each representing the unique combination of a given dietary pattern and a specified level of overall diet quality.

In other words, overlooked to date is the concept that a week is a sufficiently robust unit/time period to be “replicated” to establish a basic dietary pattern over a more meaningful interval, such as a year. With a representative dietary pattern for a week, 51 repeats of that pattern would constitute food intake for a year, and thus represent the approximate data retrieved in a traditional food frequency questionnaire.

The present invention leverages the notion that a “picture is worth a thousand words” to avoid the many, tedious words required to complete a food frequency questionnaire. Instead, the user studies a grid of images, each representing a diet of given composition and objectively established quality, and selects the diet that most closely resembles his or her own.

One of the most widely used, and best validated measures of diet quality, the Healthy Eating Index (HEI), as explained, for example, in P. M. Guenther et al., “Update of the Healthy Eating Index: HEI-2010,” Journal of the Academy of Nutrition and Dietetics, Dec. 21, 2012, is a measure of diet quality that assesses conformance to dietary guidelines for Americans. The HEI is routinely expressed in quintiles, i.e., 5 levels of diet quality. For convenience, these might be called: “poor,” “fair,” “acceptable,” “good,” and “excellent.” In addition, there are a variety of specific dietary patterns that could qualify for each quintile based on its composition. Assignment to a given quintile is based on an overall quality score, which is in turn based on nutrient data, which is in turn based on customary food and drink intake reported.

Other validated measures of overall diet quality include the Alternate Healthy Eating Index (AHEI), developed at the Harvard School of Public Health as an ‘alternate’ to the original Healthy Eating Index developed at the USDA. The AHEI is more robustly correlated with health outcomes, including risk of any major chronic disease and all-cause mortality.

In one embodiment, the present invention relates generally to a method for translating levels of diet quality into photographic representations of dietary pattern, the method comprising the steps of:

a) using a diet quality measure to identify a plurality of dietary patterns that each represent a level of diet quality for a period of time;

b) assigning a dietary score to each of the plurality of dietary patterns;

c) converting the plurality of dietary patterns into representative dietary patterns; and

d) converting the representative dietary patterns into food photographs,

wherein the food photographs depict the photographic representation of the dietary patterns for the period of time.

The dietary patterns may include any of a number of typical dietary patterns for a given population, taking into account “poor,” “good,” “better,” and “best diets for the given population.

Once the plurality of dietary patterns have been identified, a dietary score may be assigned to each of the plurality of dietary patterns taking into account variations in region, culture, diet character and nutritional quality.

The plurality of dietary patterns can then be converted into representative dietary patterns which are in turn converted into food photographs. The food photographs are used to depict a photographic representation of each of the representative dietary patterns for a period of time. The period of time is typically a week. However, the period of time may be selected to be at least one day, at least several days, one week, several weeks, one month, several months, or even one year. The analytics and specifications for each of the plurality of food photographs can then be calculated.

For example, a group of nutrition experts can use a diet quality measure, such as the quintiles of the HEI, to identify a variety of “real world” dietary patterns representing that level of quality. The diet scores could be mapped back from nutrients, to food and beverage sources, and used to generate dietary “prototypes” which can be represented by the food photographs.

Each such prototype can be readily displayed as “usual” food and beverages consumed, and these, in turn, can be composed into the subject of a photograph. Thus, this method encompasses the conversion of objective diet quality scores into representative dietary patterns by nutrition experts; and the conversion of those dietary patterns into food photographs by food stylists and photographers.

Thereafter, the photographic representation of the dietary patters can be inventoried for use in establishing or measuring dietary quality of an individual or household by an iterative process using the food photographs.

For example, in one embodiment, the present invention relates generally to a method of using a photographic representation of dietary patterns to establish a household dietary pattern, the method comprising the steps of:

presenting a relevant photo library comprising a plurality of food photographs to a member of a household, wherein each of the food photographs in the photo library depict a photographic representation of a dietary pattern for a period of time;

inviting the member of the household to selects a food photograph from the plurality of food photographs that approximates the household's current dietary pattern for a period of time;

obtaining data on each member of the household, the data comprising one or more of height, weight, age, sex, and habitual activity level; and

calculating the household dietary pattern using the information obtained in steps b) and c) using a formula for calculating calorie requirements.

In another embodiment, the present invention relates generally to a method of using a photographic representation of dietary patterns to establish a person's dietary pattern, the method comprising the steps of:

presenting a relevant photo library comprising a plurality of food photographs to the person, wherein each of the food photographs in the photo library depict a photographic representation of a dietary pattern for a period of time;

inviting the person to selects a food photograph from the plurality of food photographs that approximates the person's current dietary pattern for a period of time;

obtaining data on the person, the data comprising one or more of height, weight, age, sex, and habitual activity level; and

calculating the person's dietary pattern using the information obtained in steps b) and c) using a formula for calculating calorie requirements.

The method described herein can examine the distribution of foods and nutrients reported by an individual by their selection of a representative food photograph, and compare them to an optimal/recommended distribution of foods and nutrients. The degree of correspondence or discrepancy can be quantified using a numerical scale and the resultant scores cam be translated into quintiles of overall diet quality. Other, related measures of diet quality exist and there is the possibility that new and better measures of overall diet quality may be devised.

Any such measure, currently in use or yet to be conceived, could be applied to the methods described herein. For example, the dietary pattern may be selected from the group consisting of healthy eating index, alternative healthy eating index, healthy eating index 2010, alternative healthy eating index 2010, diet quality index, healthy eating index from food frequency score, healthy diet indicator, healthy food index, healthy food and nutrient index, recommended food score, diet quality score, diet quality, dietary guidelines index, Mediterranean diet score, Mediterranean adequacy index, alternative Mediterranean diet score, total and specific food group diversity, variations of any of the foregoing and combinations of one of more of the foregoing.

Thus, a series of food photographs can be shown to an individual, wherein the food photographs depict a photographic representation of a particular dietary pattern and the user can choose a food photograph that approximates the individual's current diet. In one embodiment, the individual can be shown a brief sequence of comparative images and be asked to select the “best image” from among the comparative images in an iterative process to arrive at the food photograph that most closely resembles the individual or the household's current diet. Thus, the photographs can be expanded into a series of N closely related photographs, wherein the N closely related photographs differ by small increments, whereby a user may be guided to a photograph that more closely approximates the user's current diet.

In another embodiment, the present invention can be used as a computer system for evaluating and customizing diet quality, the computer system comprising:

a user interface;

a photographic library comprising an expandable archive of food photographs, wherein each of the food photographs in the expandable archive of food photographs depict a photographic representation of a dietary pattern for a period of time;

a database comprising information related to dietary patterns and nutrient data;

a user information system for allowing a user to enter user data related to the user with the user interface;

a selecting system for allowing the user to select one or more food photographs from the photographic library; and

a processor, wherein said processor is capable of translating a food photograph into a corresponding, objective, validated diet quality score by a chosen metric.

This computer system can be used to provide a computerized method for measuring and evaluating diet quality.

computerized method for measuring diet quality which includes the steps of:

using the interface to select a food photograph from the plurality of food photographs that approximates the person's current dietary pattern for a period of time;

entering data in the user information system, wherein the data comprises one or more of height, weight, age, sex, and habitual activity level; and

calculating current dietary pattern using the information obtained in steps b) and c) using a formula for calculating calorie requirements.

As described herein, each photograph of the photograph menu can be expanded into a series of N closely related photographs, wherein N closely related photographs differ by small increments, whereby a user may be guided to a photograph that more closely approximates the user's current diet for a given period of time.

A photo library can be established to encompass a wide array of potential baseline diets warranting “improvement.” This library is limitlessly expandable to encompass diets from cultures all around the world.

In one embodiment, photographs for the photo library(ies) can be developed through an iterative process of ‘tetrangulation’ involving:

1) Diet Quality Expertise, in which a determination of Principal Differentiating Dietary Components (PDDCs) that differentiate among the quintiles of the AHEI-2010 is made for any given variety of diet;

2) Diet Character Variant Expertise, in which researchers and dietitians with knowledge of real-world results in large epidemiologic studies will help establish parameters for range of variants for any given population;

3) Expertise in PDDCs, in which expertise in FACTOR ANALYSIS helps link salient dietary factors to differences of both character, and quality;

4) Expertise in food choreography, which uses creative oversight of food assemblies suitable for photography, with attention to food placement, emphasis, etc.

Each entry in the library will result from input in these four areas, producing an inventory of foods suitable for photography.

To differentiate among diets that are much alike, food placement should emphasize the subtle differences; and/or interactive programming should allow for magnifying subtle differences (e.g., by placing a cursor over an image, it's main differences from a neighboring image are highlighted in text, or by selectively pulling components into the foreground/magnification).

In a broad sense, the method described herein can be used to identify any given health-related activity in a library of representative images. Thus, the method described herein can be applied, for example, to diet, exercise, stress management, sleep, etc. By far the most important application is diet, since this is the area where there is an enormous, unmet need. However, the present application is not limited to diet but is usable with any health-related behavior that can be qualified and quantified.

For example in another preferred embodiment, the present invention also relates generally to a method for translating levels of exercise quality into photographic representations of exercise pattern, the method comprising the steps of:

a) using an exercise quality measure to identify a plurality of exercise patterns that each represent a level of exercise quality for a period of time;

b) assigning an exercise score to each of the plurality of exercise patterns;

c) converting the plurality of exercise patterns into representative exercise patterns;

and

d) converting the representative exercise patterns into exercise photographs,

wherein the exercise photographs depict the photographic representation of the exercise patterns for the period of time.

These exercise patterns may include any of a number of exercises, including, for example, exercises such as walking, running, biking, swimming, yoga, team sports, weight lifting and combinations of one or more of the foregoing. The exercise photographs can be arranged in a photo library and used in the manner described above to characterize a baseline and goal exercise pattern. In a similar manner, the computer system described above for evaluating and customizing diet quality may be adapted to evaluate and customize exercise quality.

In another embodiment, the method described herein can be used to address public health priorities, notably malnutrition/food insecurity, around the globe. The process begins with plausible dietary patterns for any given subject/population, catalogued by region, culture, diet character (e.g., vegetarian, flexitarian, Mediterranean, etc.) and objectively established nutritional quality, such as quintile of the Alternative Healthy Eating Index-2010. Each dietary option is represented in a single photograph of habitually consumed foods, each photograph representing a typical week's worth of foods in typical proportions, with the image allowing readily for distinction between packaged foods and foods prepared at home. Any given subject reviews a small set of plausible images from an established, regionally/culturally-relevant library, to select the “best fit” from among them. This process is then repeated several times to arrive at the closest possible approximation of personal (or household) dietary pattern. The process requires only seconds, and is directly analogous to the process used for determining the ideal eyeglass prescription with great efficiency, and nearly perfect fidelity. Once an image from the library is selected, objectively measured diet quality is immediately available. Measures of nutrient intake in proportion to calories are immediately available. No n-of-1 data analysis is needed, because every entry in the library is pre-analyzed, and thus, data generation is infinitely scalable. All that is required to quantify nutrient intake for an individual is a calculation of their average energy intake, which can be determined using standard formula known to those skilled in the art, and minimal information, notably: age, sex, height, weight, weight trajectory, and usual activity level. While still allowing for some quantitative error, this approach compresses such error to within a range of plausible values, and thus promises to be much more accurate and precise than existing methods.

Any given user of the system can indicate whether entry is for individual or household. The method thus allows for the identification of household-wide dietary pattern and diet quality, and addresses dietary practices that include shared food plates. If an image is chosen to represent household intake, quantified nutrient intake for each individual can be obtained by use of the same standard formula, applied separately to each household member, adult or child.

In one embodiment, the invention described herein can be used to assist a user in transitioning from his current diet to a “goal” or “optimal” diet. In this instance, the user reviews images of dietary patterns representing higher levels of quality to select a goal diet.

The system then generates user-specific guidance, in terms of foods, beverages, and behaviors, to assist navigation from the CURRENT dietary pattern, to the preferred, GOAL dietary pattern. In one embodiment, this may feel much like a video game, and the literal navigation through a “maze,” with the system providing recognition/reward for progress toward the goal, and continuous guidance and course corrections. Thus, as described herein, the photograph library described herein can be used in a computer interface as a way of establishing a base dietary quality and then to selection a more “optimal” or goal diet.

As described herein, the user never needs to enter details of their dietary intake; they merely examine a set of photographic images representing differing, general dietary patterns, and select from the closest approximation to their dietary intake from among them.

A “game” for any given user can be initiated with the following steps:

1) The user examines a small series of photographs of dietary patterns, and clicks on the photograph that most closely resembles their current baseline diet for a given period of time. The photo library can be established to encompass a wide array of potential baseline diets warranting “improvement.” This library is limitlessly expandable to encompass diets from cultures all around the world.

2) The user reviews a small series of photographs representing variations on the theme of an “optimal diet” and chooses the preferred destination. The range of objective “optimal” diets is narrower than the range of baseline diets, but it, too, is almost limitlessly customizable across an array of cultures and traditions. Examples of distinct dietary patterns that might all be “optimized” include, for example, vegetarian, flexitarian, or American-style, Mediterranean, Asian, and Paleo, among others.

3) The user chooses the route priority from baseline diet to goal diet: easiest or fastest (i.e., a longer but more gradual hiking trail; or a shorter, but steeper and more rugged one) and clicks “PLAY”

A grid of diet images is shown below in Table 1 as being illustrative of the expandable diet quality map. The expandable map may have X rows of cells and Y columns of cells through which a user may navigate. While the expandable map shows a five by five grid of cells, the invention is not limited to this embodiment and X and Y may be any number, each independent of the other. For example, X and Y may each independently be 2 or more, or may be 3 or more or may be 10 or more. The numerical value of X and Y is not critical, what is more important is the ability of a user to navigate from one cell in the grid to another adjacent cell in the grid to move from a baseline to a more optimal diet.

TABLE 1
Diet Quality Photo Navigation matrix. Each number represents a
tier, or quintile, of objectively measured overall diet quality, and each
letter represents one dietary variant or pattern at that level. Each
cell in the table is populated with a photographic image of the given
dietary pattern.

Diet Quality Quintile

| | 1 | 2 | 3 | 4 | 5 |
|---|---|---|---|---|---|
| Dietary | A | A | A | A | A |
| Variants | B | B | B | B | B |
| | C | C | C | C | C |
| | D | D | D | D | D |
| | E | E | E | E | E |

In the gamification of the method described herein, the sophistication of objective measures of overall diet quality meets the simplicity of a visual analog scale; and these, in turn, meet the user-friendliness and fun of Sudoku, a board game, a treasure hunt, and/or a favorite hike. Steps through the game are guided by the equivalent of GPS.

A discrete set of modifications in habitual food/beverage intake separates each cell in the grid from adjacent cells. Thus, progress can be made through the grid, one cell at a time, by adopting a small, discrete set of new dietary “habits”—which can be queued up by an application running on a smart watch, phone, tablet, or computer.

Examples of incremental dietary changes that could shift overall diet quality include, for example:

1) using olive oil instead of butter or margarine on bread;

2) drinking water instead of soda;

3) using oil and vinegar instead of a commercial salad dressing;

4) eating whole grain bread or pasta instead of a refined grain product;

5) including a mixed green salad with dinner;

6) eating beans or lentils rather than meat;

7) avoiding processed/deli meats;

8) eating fresh fruit as a snack; and

9) eating raw nuts as a snack.

All such shifts can be personalized, based on the foods currently being consumed and the desired goal diet, so that the sequence of incremental changes “add up” to a total transformation of the diet from baseline, to goal. Assuming that each column in the grid represents a tier of DIET QUALITY and each row represents a different dietary variant at that level of quality, then movement from row to row represents a change in diet CHARACTER and movement from column to column represents a change in diet QUALITY, measured objectively by any of several well-established methods. The EASIEST route from baseline to goal would involve progress one-cell-at-a-time through the grid moving horizontally, or vertically, in sequence.

For example, if the baseline diet were a standard American diet of low quality, and the goal diet were an optimal vegetarian diet, this would involve changes in BOTH diet quality and character. These could be achieved by adopting new dietary habits in sequence to move one horizontal or vertical cell at a time.

Alternatively, a more ambitious user could choose to acquire more new dietary habits at a time, and change both quality and character of diet simultaneously by moving through the cells more quickly. These options are displayed schematically below in Table 2.

Furthermore, the method described herein is further customizable in a wide variety of ways, including, but not limited to:
user plays against any number of other users, competing to reach goal in least time
user specifies time for new dietary habit acquisition (e.g., one week per habit; two weeks; etc.)
user specific number of new dietary habits acquired simultaneously
user specifies whether new dietary habits INCLUDE or EXCLUDE food preparation
user chooses to engage other household members in family-based diet change

In the illustrative grid shown below in Table 2, each COLUMN represents a level of diet quality, and each ROW represents a different dietary variant at that level of quality. As shown in the legend, diets range from “standard” to “excellent,” and can span a limitless variety of preferred patterns and ethnicities.

The exact number of new “dietary habits” required to move from a given cell to another is X, where X is determined by experts in nutrition/behavior modification. This number may be different for moving horizontally and vertically within the grid, and need not be constant within rows or columns.

For the purposes of illustration, let's suppose that horizontal movement from any given cell to an adjacent cell requires 2 new habits, and movement to an adjacent vertical cell requires 3 new habits (examples of such habits may include: drinking water instead of soda; using olive oil instead of corn oil; eating whole grain bread instead of white bread; eating a mixed green salad at dinner; having whole grain cereal for breakfast; snacking on raw or dry-roasted nuts; including at least one fresh fruit at breakfast; etc.).

The complete grid will be distinct for each individual, depending on baseline and goal diets. For any given individual, the ‘route’ from baseline to goal will involve some specific number of cells, each representing an incremental improvement in overall diet quality, and incremental movement toward the goal diet.

Each two neighboring cells along the route are separated by a set of Principal Differentiating Dietary Components (PDDC), i.e., the salient food, beverage, and behavioral differences that distinguish between the two.

As an example, a user starting with a typical America diet might routinely be consuming fast food, soda, highly processed foods, white flour, added sugars, fried foods, ‘junk’ foods, snack foods, processed meats, and sweets. In other words, this diet may include excess sugar, salt, saturated fats, variety, food chemicals, and calories.

The goal diet for this individual may be an optimal vegetarian diet, and the route from baseline to goal would involve N incremental steps from cell, to neighboring cell. The individual would have the opportunity to specify a larger or smaller value for N, and make smaller changes (i.e., get to goal more slowly) or larger changes (i.e., get to goal faster).

A route customizing algorithm (RCA) can be used to combine information about baseline, goal, and preferred pace to generate a sequence of PDDCs to be addressed. As an example, the route from “typical American diet” to “optimal vegetarian diet” could proceed through the following steps:

1) replace soda with diet soda; replace snack foods with raw nuts;

2) replace diet soda with fruit-flavored seltzer; replace white bread with whole grain bread;

3) replace seltzer with water; replace breakfast sandwiches with whole-grain cereal;

4) add fruit to breakfast cereal; replace deli meats with Hummus;

5) replace meats with vegetarian alternatives (beans, lentils) twice weekly;

6) replace meats with vegetarian alternatives 5 times weekly;

7) replace all meat dishes with vegetarian alternatives.

TABLE 2
Illustrative Grid of Diet Quality

| | | | | |
|---|---|---|---|---|
| SWD-1 | IWD-1 | AWD-1 | GWD-1 | EWD-1 |
| A | B | C | D | E |
| SWD-2 | IWD-2 | AWDv-2 | GWDv-2 | EWDv-2 |
| F | G | H | I | J |
| SWD-3 | IWD-3 | AWDv-3 | GVD | EVD |
| K | L | M | N | O |
| SWD-4 | IWD-4 | AWDv-4 | GAD | EAD |
| P | Q | R | S | T |
| SWD-5 | IWD-5 | AWDv-5 | GMD | EMD |
| U | V | W | X | Y |

S = standard
I = improved
A = acceptable
G = good
E = excellent
WD = Western diet
WDv = variant on Western Diet
VD = Vegetarian diet
AD = Asian diet
MD = Mediterranean diet

For any given player, the route through the grid is customized with a route customizing algorithm (RCA). The RCA is built into the operating software of the application or technology-based program, and determines the total set of new habits, and their sequence, for a given user based on various factors including, for example, the starting cell, the destination cell and route preferences. The software application or technology-based program then uses the RCA to sequence delivery of new dietary habits, and related coaching, to any given user.

The specific, predominant food and beverage “differences” between any given cell in the matrix at entry (e.g., 2C) and the user's specific goal cell (e.g., 5D) could be elaborated in a step-by-step manner. So, for example, there might be “N” predominant changes in habitual food and beverage intake to move from cell 2C to cell 3C; and another N to move from 3C to 4C; and so on. There might be X habit changes required to move from 4C to 4D.

As an illustration, a user wanting to go from baseline A to Goal Y could chose the ‘easiest’ route, and proceed in clusters of 2-3 new habits at a time as follows: A to B to C to D to E to J to O to T to Y.

Another user wanting to go from baseline A to Goal Y as quickly as possible (i.e., the equivalent of a shorter, but steeper hike) could proceed through a sequence of 5 new habits at time as follows: A to G to M to S to Y.

The method described herein establishes a complete library of “habit changes” that lead from ANY GIVEN CELL in the matrix to ANY OTHER, and customizes the delivery of them to a user based on his or her PERSONALIZED statement of baseline, goal, and even preferred route. The experience of the coaching is thus unique to each user, and feels like a game: a maze, treasure hunt, or movement of a piece across a board game surface. Interim adjustments could be made at any time by indicating a NEW, current baseline position in the grid- and ‘recalculating’ the preferred route to the destination, much as GPS systems do. Here, however, the navigation is not about geographic position, but rather about habit acquisition, with the specific habits determined by the steps required to move from one's current position to the next, more preferred position in the matrix.

While the representation of dietary pattern by a photographic image will inevitably be prone to some loss of detail and thus inaccuracy, the current methods of dietary intake are no less so. Despite intense interest in technology-based methods of dietary intake data capture, such as smart phones, no such reliable method exists, and none is yet even in view. All such methods thus far envisioned still require active work by the end-user, and thus constitute a barrier to entry.

In contrast, the method described herein replaces this entirely with a gaming interface; the end user merely scans a series of images, chooses the one that is the “best fit,” and the game begins.

In another embodiment, instead of a technology-based program, the matrix described herein can be depicted as a board or card game or in a book. In this instance, the user navigates through the game in a similar fashion as they would through the technology-based program. For example, the book or game may contain a series of photographs that would allow the user to choose their baseline diet and then further instructions would be provide to progress through the book or game while adopting new dietary habits.

The delivery of dietary coaching may continue after a user reaches their destination cell. Even within a given tier of diet quality (i.e., a column in the grid), there is a range of overall diet quality, and a range of dietary practices available. The system may thus continue to provide guidance to new and better dietary practices; and/or to queue up new habits that make the maintenance of more healthful eating easier and more convenient. Thus, there is a maintenance option embedded within the platform. In addition, there is the possibility of ‘lapses’ over time, meaning backward movement to a dietary pattern of lower quality. The game could be replayed at any such time, with the user identifying their current position in the grid, and their preferred destination.

As another example, the starting point for a given player might be a standard American dietary pattern and the player might then improve their diet to more closely resemble a standard diet of Western Europe, in this case, France. Finally, the player might reach her/his goal of a Greek, Mediterranean-style diet.

While the images shown in FIGS. 1-3 display both food and families, the intent for the photograph library of the invention is to show food only, arranged in a manner to convey more clearly the specific, distinguishing features of that diet at a virtual glance.

In one embodiment, players may enter personal information (i.e., height, weight, sex, activity level) and obtain via the same interface additional guidance, related, for instance, to recommended calorie intake; serving sizes; etc. This information is not necessary to play, but is fully compatible with the interface. In another embodiment, the interface may be linked to a fitness interface, so that a player is receiving guidance for diet and physical activity improvements CONCOMITANTLY. While this is optional, in this mode, the diet tips provided CAN BE ADJUSTED TO ADDRESS the physical activity pattern and goals. Furthermore, an interactive system can be used to “plug in” to the program described herein to provide access to recipes/options.

The elements described herein may be delivered via any suitable technology platform, including via various smart devices (i.e., computer, smart phone, tablet, etc.) as well as a wide array of wearable fitness devices, such as FitBit, etc.

In one embodiment, the photographs in the photo library can be CUSTOMIZED so that they are limited to those of interest to a given player, e.g., specific to a cultural practice (Kosher; Halal; etc.) or dietary commitment (e.g., vegetarian or vegan; etc.) or to take into account food allergies.

Finally, while the features described herein provide an overview of the components of the invention, it is intended that the specific details, such as the exact dietary habits that separate each cell in a given grid from adjacent cells, can be determined by a small group of experts.

### Example 1. Steps in Populating the Matrix

1) A well-known, validated measure of diet quality is selected to establish an ordinal scale for the range of scores (e.g., quintiles)

2) Some number of dietary variants are defined, meaning a composition of routinely consumed foods and beverages, representative of each level of quality in the matrix. In other words, diets can vary in both character and quality. A variation in character would be the distinction between a vegetarian diet, and a Paleo diet. A variation in quality would be a high-quality vegetarian diet versus a low-quality vegetarian diet.

In order to provide any given user of the method with sufficient images to find a close match to their baseline and goal diets, these variations in both character and quality are represented by a suite of foods/drinks captured in a photograph. The ideal representation of, for instance, a “poor quality” vegetarian diet versus a “good quality” vegetarian diet is based on real-world reporting in diet intake studies.

3) The principal differences are defined, in terms of routinely consumed foods and beverages, between each dietary variant at each level of quality, and the adjacent cells—each representing EITHER a shift in dietary pattern at a given level of quality, OR a shift in diet quality within a basic dietary pattern (e.g., vegetarian; Mediterranean; etc.). For instance, it is possible to have a POOR QUALITY vegetarian diet, and such a player might stay within the ROW representing vegetarian diets from start to finish, but would only need to improve the quality of that pattern by moving across the DQPN grid, column by column.

4) The complete set of “navigational steps” are compiled that represent changes in habitual food and beverage intake leading from ANY GIVEN CELL in the matrix, to any other

5) A photographic interface is established (i.e., via computer, tablet, smart phone, smart watch, etc.) that allows a user of the system to select the image MOST like his/her current diet.

6) A photographic interface is established (via computer, tablet, smart phone, smart watch, etc.) that allows a user of the system to select the image, from among diets of quality higher than baseline, most like his/her goal diet (either ultimate goal, or immediate goal).

7) The user is provided with guidance toward their stated goal based on customized navigational steps, via computer, tablet, smart phone, smart watch, etc.

8) Progress is assessed at intervals; redirect as warranted; provide relevant encouragement, recognition, and/or rewards.

For example, at specific or personally selected intervals, a player will be invited to look again at photos to determine their current status- and thus gauge progress toward goal. At each such juncture, players can revise the game as inclined—e.g., go from fastest to easiest route; alter the goal; etc.

### Example 2. Obtaining Closest Approximation of Baseline Diet

1) A subject is shown images from a photograph library and asked to choose the closest approximation of baseline diet for a period of time (i.e., one week); the images are VERY distinct. For example, the photograph library may include photographic representations of a ‘typical American diet,’ including meat, soda, and fast food; and an ‘optimal vegetarian diet’ showing no soda, no meat, no fast food, and in their place fresh vegetables, fruits, whole grains, a pitcher of water, etc.

2) Whichever image is chosen is then subjected to an EXPLODE function, in which N new food photographs, representing much more closely related variants of that dietary pattern are shown; and the subject is once again prompted to choose the closest approximation of baseline diet, in order to get an even closer fit. It is noted that N may be any number. In some embodiments, N is 2 or 3 or 4 or more. While there is no upper limit to N, too many photographs would make it more difficult for the subject to choose and may be confusing.

3) Step 2 can be repeated any number of times, based on the extent of the image library, to arrive at the diet MOST proximal to the subject's actual diet (i.e., best fit)

4) If at any given step, the subject chooses “I'm not sure,” the N images are replaced with X images representing the extremes of the current set. It is noted that X may also be any number. In some embodiments, Z is 2 or 3 or more. While there is no upper limit to X, too many photographs would again make it more difficult for the subject to choose and may be confusing; and

4a) the subject is prompted to choose; and

4b) if they choose, the process is repeated, X image choices at a time, until the final dietary approximation (best fit) is reached

5) If the subject again clicks “I'm not sure,” the system is prompted to display THE MAIN DIFFERENCES BETWEEN CHOICE X₁ AND CHOICE Xₙ, in terms of routinely consumed foods, beverages, brands, etc.

5a) the subject is then prompted to choose; and

5b) the process repeats.

As described herein, as user first selects a photograph that most closely resembles their current diet. Once they choose a photograph, the process continues until the ‘best fit’ is achieved. However, as the photographs get more and more alike, choosing between the photographs becomes more difficult. Thus, if the user cannot tell which of, for example, 4 photographs is the best fit, the system reduces the number of choices, for example, to 2 photographs, which may be the two photographs that are most different from within the group of four photographs. The user is then prompted to choose from the two photographs. If the user is still unable to choose from the two photographs, the system describes (in words or graphics) the main difference(s) between the photographs to facilitate a choice.

The closest approximation to the subject's diet from the entire photo library (best fit) has now been identified. This dietary pattern corresponds to specific, well-known nutrient intake levels/1000 kcal.

All that remains to quantify the subject's nutrient intake is to establish habitual calorie level; this is readily calculated with height, weight, sex, age, and activity level, using metrics such as the Harris-Benedict or Mifflin-St. Jeor equations for determining basal metabolic rate, which equations are well known to those skilled in the art.

Detailed dietary intake data can thus be generated for a subject by navigating through a set of photographs and answering a few high level questions. No dietary intake data entry is required. These high level questions can include, for example, age, sex, height, weight, and habitual activity level (which can be selected from a standard ordinal scale).

Thereafter, as described herein, the user can choose the route priority through the grid and the user is provided with the first set of dietary habits to begin advancing through the grid.

As can be seen, the methods described herein can be extended broadly to nutrition research. Notably, the process described herein also requires no literacy; can distinguish between packaged/processed foods and foods prepared in the home; is ideally suitable for specific challenges in remote field settings (such as lack of electricity, poor lighting, unreliable internet) because there is no need for consistent (or any) access to power or the Internet and no photos are taken at the time of data collection. For application in remote field settings, the relevant photo library can be presented in hard copy, and quantification of nutrient intake can be determined with a hand-held calculator, or subsequently when back at a computer. Finally, the process described herein poses no threat to privacy, which is an issue with passive image capture technology.

Thus, it can be seen that the methods described herein can be used to create a photograph library to measure incremental, objective change in the diet composition and quality of a person or household.

A person or household can use the photograph library to define the specific food-by-food changes required for an individual or household to navigate to a given, “better” diet (objectively better for health) and to provide specific, customized guidance about the steps required to progress accordingly.

The photograph library can also be used to assist and gauge the progress of an individual or household toward a given “goal” diet representing better quality (i.e., better for health)

For purposes of research/nutritional epidemiology, the more accurate the representation of a given subject's diet, the better. A degree of accuracy not required for consumer facing programs is desirable.

In addition, nutritional epidemiology may have as a goal the generation of nutrient intake values. This requires both quantitative and qualitative assessments of dietary intake. The method described herein can be applied to both, in a manner roughly analogous to eyeglass lens optimization. The method is also readily customized by high-level demographic information such as: nationality; ethnicity of diet; etc.

Because dietary intake assessment with the process described herein is almost instantaneous, nearly effortless, and potentially even fun, the process described herein allows for limitless applications in apps, interactive websites, and games. Identification of a “goal” diet is as streamlined as identification of baseline diet and with attention to the incremental dietary changes along the way from baseline to goal, the process described herein is designed to identify key, desirable dietary changes; to address these changes in a logical sequence; and to “coach” the process of dietary change. The platform can function in this manner on its own (i.e., app, website, wearable health tech) or can be used by to enhance the guidance of a human health coach.

Finally, while the present invention is described in regards to the application of characterizing and evaluating diet quality and customary diet patterns and providing guidance to a user to modify their diet from a baseline diet to a goal diet using a series of incremental photographs arranged in a photo library, the present invention is not limited to the evaluation of diet quality. Rather, the invention described herein is usable to characterize and evaluate other health related parameters and combinations of parameters including, but not limited to, exercise, stress management, sleep and other health related parameters that are capable of being represented using a series of incremental photographs and for which an individual may desire to modify behavior from a baseline behavior to a goal behavior using a plurality of incremental steps. Thus, the photo library may comprise a series of photographs that illustrate the particular health related parameter.

Thus, in a broad sense, the present invention relates to a method for translating levels of a selected health quality parameter into photographic representations of a selected health quality pattern, the method comprising the steps of:

a) using a health quality measure to identify a plurality of the selected health quality patterns that each represent a level of health quality for a period of time;

b) assigning a health score to each of the plurality of the selected health quality patterns;

c) converting the plurality of the selected health quality patterns into representative health quality patterns; and

d) converting the representative health quality patterns into photographs that represent the selected health quality pattern,

wherein the photographs depict the photographic representation of the selected health quality patterns for the period of time.

As described herein the selected health quality may comprise one or more of diet, exercise, sleep, stress management and combinations of one or more of the foregoing.

In addition, in a broad sense, the present invention also relates generally to a computer system for evaluating and customizing a selected health quality, the computer system comprising:

a user interface;

a photographic library comprising an expandable archive of photographs, wherein each of the photographs in the expandable archive of photographs depict a photographic representation of selected health quality patterns for a period of time;

a database comprising information related to health quality patterns and related data;

a user information system for allowing a user to enter user data related to the user with the user interface;

a selecting system for allowing the user to select one or more photographs from the photographic library; and

a processor, wherein said processor is capable of translating a photograph into a corresponding, objective, validated health quality score by a chosen metric.

Furthermore, it is noted that initial efforts may focus on the development of photo libraries pertinent to predominant, prevailing dietary patterns in major world populations, and will apply to hundreds of millions of people. Ultimately, though, the method is expandable to apply to any dietary pattern prototype relevant to any sizable population in the world. We may define “sizable” operationally as greater than or equal to 0.001% of the total human population, or roughly, 80,000 individuals.

To achieve that goal implies a photo library that could run to thousands of images. That, in turn, raises two obvious challenges: use, and development.

Use: it would be overwhelming to review and consider hundreds or thousands of images to find the ‘best fit’ diet for yourself. This problem can be avoided using filters, including but not limited to: where in the world are you and your diet? (region); basic diet character, and whether or not your diet is typical for that region; major dietary restrictions (e.g., food sensitivities such as gluten; food allergies; religion-based prohibitions; ethics-based prohibitions; medical prohibitions; etc.); and so on. Applying just a few, high-level filters can reduce the relevant photo library for any individual to a much smaller, more easily navigated subset.

There are multiple ways in which these filters can be handled. Firstly, in a more resource-intensive approach, the photo library can be built and developed to encompass all relevant combinations.

In another alternative, which may be less resource-intensive, photos and filters in the photo library can be combined. For instance, a single photograph might represent “US/vegan diet/high quality.” Then, “gluten free” might be assigned as filter. Rather than having a separate photograph of a high quality, gluten-free, US-based diet, we might instead simply assign a different set of nutritional values to the SAME photograph once a user selects that filter, or what we might call a “modifier.”

It is further contemplated that the use and development of photo libraries may be outsourced to create and develop subsidiary photo libraries.

Thus, in practice, nutrition experts in any given site around the world can develop locally customized versions of the photo library following prescribed guidelines. Thus, it is contemplated that while photo libraries may be developed by third parties, a comprehensive review of these photo libraries would also be undertaken to be sure that the photo libraries meet the standards and guidelines outlined herein.

The advantage of this approach is that the development of worldwide photo libraries can be accelerated, while taking advantage of local nutritionists who are most familiar with local customs.

1-22. (canceled)

23. A method of playing a fitness and nutrition education game, the method comprising the steps of:
providing a library of unique photographic images, wherein each unique photographic image depicts a different objective level of diet quality for a different type of diet for a period of time, and wherein each photographic image depicts representative types and quantities of foods and/or beverages consumed at the level of diet quality for the type of diet for the period of time, and wherein the library comprises unique photographic images identified as BASELINE levels of diet quality and unique photographic images identified as GOAL or OPTIMAL levels of diet quality;
providing a diet quality map, wherein the diet quality map comprises a grid of cells, wherein each unique photographic image in the library of unique photographic images corresponds to a cell in the grid of cells and wherein each photographic image further represents a dietary variant or pattern of each different level of diet quality for each different type of diet;
wherein the player:
a) selects a photographic image from the photographic images identified as BASELINE level of diet quality to represent a baseline level of diet quality of the player;
b) selects a photographic image from the photographic images identified as GOAL or OPTIMAL level of diet quality to represent a goal level of diet quality of the player;
c) selects a route priority from the BASELINE level to the GOAL or OPTIMAL level of diet quality; and
d) navigates through the grid of cells in the diet quality map from the BASELINE level to the GOAL or OPTIMAL level by adopting new dietary habits/incremental changes.

24. The method according to claim 23, wherein the diet quality map is arranged on a game board.

25. The method according to claim 24, wherein the player competes against other players to reach the goal level of diet quality in the least amount of time, wherein the first player to navigate from the BASELINE level to the GOAL or OPTIMAL level of diet quality on the game board is declared the winner of the game.

26. The method according to claim 23, wherein the game provides instructions for the players to navigate or progress through the grid of cells of the game.

27. The method according to claim 23, wherein the player competes against himself/herself to navigate from the BASELINE level to the OPTIMAL or GOAL level of diet quality of the player.

28. The method according to claim 26, wherein the player specifies a time for acquiring new dietary habits to progress through the cells of the game.

29. The method according to claim 26, wherein the player specifies a specific number of dietary habits to acquire to progress through the cells of the game more rapidly.

30. The method according to claim 25, wherein the player competes against other players in their household in a family-based challenge.

31. The method of claim 23, wherein the game is a video game played on a graphical user interface.

32. The method of claim 31, wherein a player enters personal information into the graphical user interface, wherein personal information comprises one or more of height, weight, age, sex, and habitual activity level.

33. The method of claim 31, wherein the graphical user interface depicts a plurality of comparative photographic images identified as BASELINE levels of diet quality, wherein a user can select a photographic image from among the plurality of photographic images identified as BASELINE levels of diet quality.

34. The method of claim 31, wherein the graphical user interface depicts a plurality of comparative photographic images identified as GOAL or OPTIMAL levels of diet quality, wherein a user can select a photographic image from among the plurality of photographic images identified as GOAL or OPTIMAL levels of diet quality.

35. A fitness and nutrition education game comprising:
a. a plurality of unique photographic images, wherein each unique photographic image depicts a different objective level of diet quality for a different type of diet for a period of time, and wherein each photographic image depicts representative types and quantities of foods and/or beverages consumed at the level of diet quality for the type of diet for the period of time, and the plurality of unique photographic images comprise unique photographic images identified as BASELINE levels of diet quality and unique photographic images identified as GOAL or OPTIMAL levels of diet quality;
b. a diet quality map, wherein the diet quality map comprises a grid of cells, wherein each unique photographic image corresponds to a cell in the grid of cells and wherein each photographic image further represents a dietary variant or pattern of a level of diet quality for a type of diet; and
c. instructions for one or more players to navigate through cells in the grid of cells.

36. The fitness and education game according to claim 35, wherein the game is played on a game board.

37. The fitness and education game according to claim 35, wherein the game is accessed via a graphical user interface.

38. The fitness and education game according to claim 35, wherein the instructions invite the one or more players to:
a. select a photographic image from the photographic images identified as BASELINE level of diet quality to represent a baseline level of diet quality of the player;
b. select a photographic image from the photographic images identified as GOAL or OPTIMAL level of diet quality to represent a goal level of diet quality of the player; and
c. select a route priority from the BASELINE level to the GOAL or OPTIMAL level of diet quality.
